(19) United States
(12) Patent Application Publication
(10) Pub. No.: US 2009/0232436 A1
(43) Pub. Date: Sep. 17, 2009

(54) Bicycle bearings

(75) Inventor: Thomas Goring, Karlsruhe (DE)

Correspondence Address: WOMBLE CARLYLE SANDRIDGE & RICE, PLLC, ATTN: PATENT DOCKETING, P.O. BOX 7037, ATLANTA, GA, 30357-0037, US

(73) Assignee: KHE Fahrradhandels GmbH, Karlsruhe (DE)

(21) Appl. No.: 12/075,867

(22) Filed: Mar. 14, 2008

(51) Int. Cl. F16C 13/02

(52) U.S. Cl. 384/545

(57) ABSTRACT

A bicycle has a frame with a bottom bracket shell, with the bottom bracket shell holding a bottom bracket for bearing a crank shaft having crank arms carrying pedals, wherein the bottom bracket comprises at least one bush bearing.

### TECHNICAL FIELD

One aspect of the present invention relates to a bicycle that has a frame with a bottom bracket shell, with the bottom bracket shell holding a bottom bracket for bearing a crank shaft having crank arms carrying pedals.

### BACKGROUND OF THE INVENTION

It is conventional for the bottom bracket of a bicycle to comprise ball bearings for bearing the crank shaft. Thus, the crank shaft can rotate substantially without friction, i.e. pedaling is not rendered difficult by friction. Because the bottom bracket shell has a inner diameter that is larger than the outer diameter of the crank shaft plus the size of the ball bearings, a cap or another adapter made of steel may be screwed into the bottom bracket shell to reduce the inner diameter.

### BRIEF SUMMARY OF SOME ASPECTS OF THE INVENTION

One aspect of the present invention is the provision of improvements to a bicycle of the type described above. In accordance with one aspect of the present invention, a bicycle has a frame with a bottom bracket shell, with the bottom bracket shell holding a bottom bracket for bearing a crank shaft having crank arms carrying pedals, wherein the bottom bracket comprises at least one bush bearing (e.g., a bushing that is used as a bearing). Thus, friction between the bottom bracket and the crank shaft occurs, which makes it easier to perform tricks on a BMX freestyle bicycle.

Other aspects and advantages of the present invention will become apparent from the following.

### BRIEF DESCRIPTION OF THE DRAWINGS

The invention is explained in more detail with reference to an exemplary embodiment depicted in the drawings, in which:

FIG. 1 is a partially sectional bottom view of a portion of the exemplary embodiment,

FIG. 2 includes a side view and a cross-sectional sectional view of the bottom bracket of FIG. 1,

FIG. 3 a partially sectional view like FIG. 1, with another (e.g., an alternative) bottom bracket for use in place of the bottom bracket of FIG. 1,

FIG. 4 a left side view of the exemplary embodiment, and

FIG. 5 is a partially sectional side view of a portion of the exemplary embodiment.

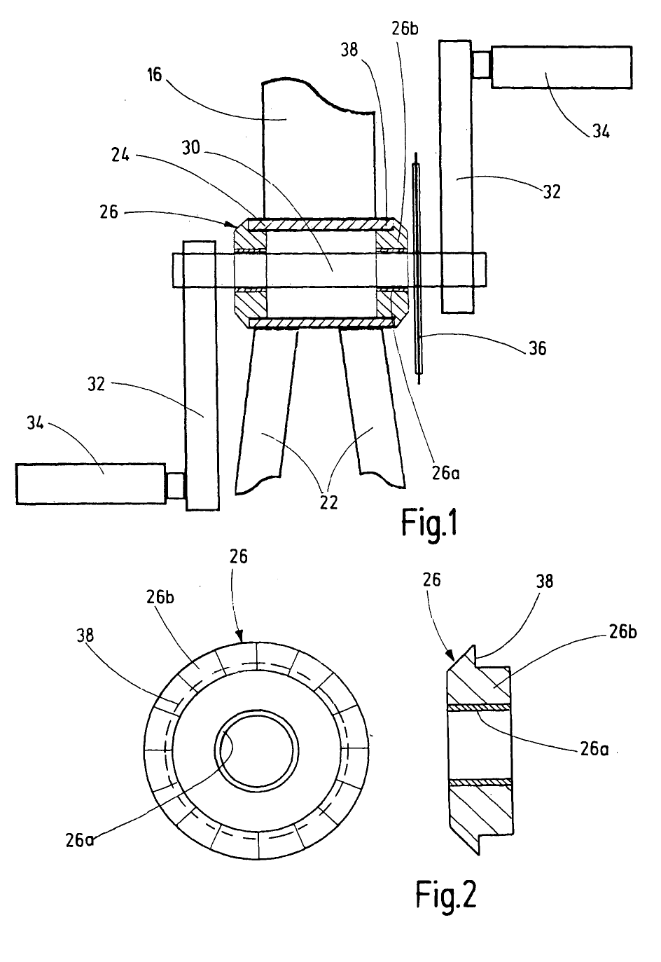

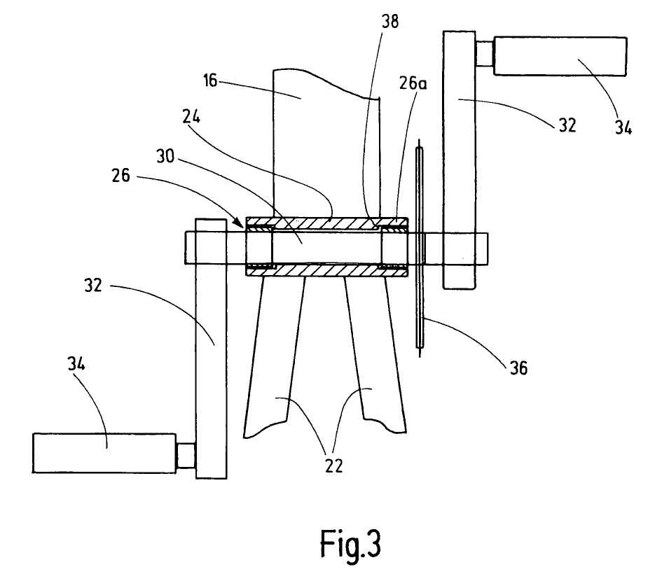

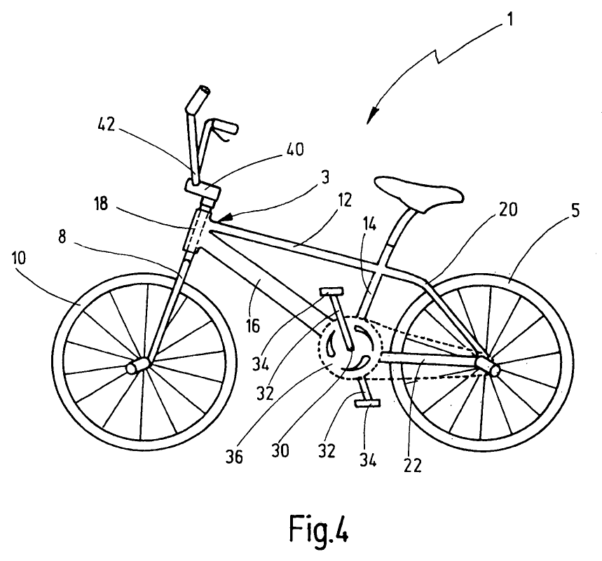

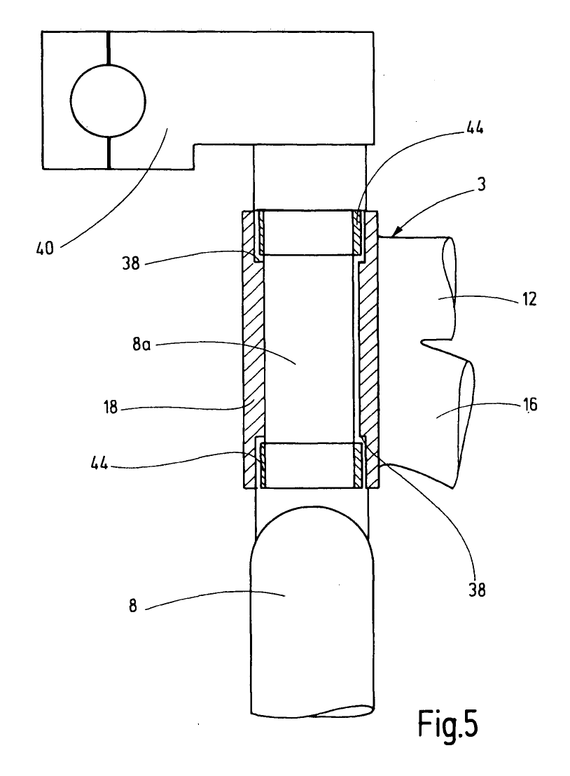

### DETAILED DESCRIPTION OF EXEMPLARY EMBODIMENT

A bicycle 1 has a frame 3 that supports a rear wheel 5 at the rear of bicycle 1 and, by way of a fork 8 at the front of bicycle 1, the frame 3 supports a front wheel 10 of bicycle 1. The frame 3 is of a diamond-like form comprising or consisting of a main “triangle” having a top tube 12, a seat tube 14, a down tube 16 and a short head tube 18, and two rear “triangles”, each having a seat stay 20 (e.g., tube), a chain stay 22 (e.g., tube), and the seat tube 14 as a common part of all rear “triangles”.

A bottom bracket shell 24 is provided where the down tube 16, the seat tube 14, and the two chain stays 22 are connected (e.g., the down tube 16, seat tube 14, and chain stays 22 are mounted (e.g., welded) to the bottom bracket shell 24). The bottom bracket shell 24 is a short tube running side to side, a direction which is called “axial” hereinafter. With respect to the axial direction of the bottom bracket shell 24, the seat tube 14, the down tube 16, and the chain stays 22 are projecting from the bottom bracket shell 24 in a direction which is called “radial” hereinafter.

The bottom bracket shell 24 holds a bottom bracket 26, and the bottom bracket 26 bears a crank shaft 30, which is arranged in the axial direction. A crank arm 32 is mounted on each of the two ends of the crank shaft 30, and each crank arm 32 bears a pedal 34 in a conventional manner. On one side of the bottom bracket shell 24, a front gear 36 is mounted on the crank shaft 30. The front gear 36 is typically mounted for rotating with the crank shaft 30 in a conventional manner, with the front gear 36 typically being linked, in a conventional manner, to the rear wheel 5 via a chain and rear gear.

According to the exemplary embodiment of the invention, the bottom bracket 26 comprises two bush bearings 26a (e.g., bushings that are used as bearings), with the bush bearings 26a being arranged in the axial direction and fixed to the bottom bracket shell 24. According to the exemplary embodiment of the invention, the bush bearings 26a are not antifriction bearings (e.g., the bush bearings 26a are not ball bearings). More specifically according to the exemplary embodiment of the invention, the inner diameter of the bush bearings 26a corresponds to (e.g., is substantially the same as, such as by being slightly larger than) the outer diameter of the crank shaft 30, so that the bush bearings 26a are configured as “friction bearings” (e.g., there is typically direct, sliding contact between the inwardly facing inner surfaces of the bush bearings 26a and the corresponding outwardly facing outer surfaces of the crank shaft 30, and any provision of fluid lubricant (for reducing the friction associated with the direct, sliding contact) typically does not result in a film of lubricant that is thick enough to avoid direct, sliding contact between the inwardly facing inner surfaces of the bush bearings 26a and the corresponding outwardly facing outer surfaces of the crank shaft 30 (e.g., the bush bearings 26a are not fluid bearings)).

The radial size of the bottom bracket shell 24 offers different realizations of (e.g., designs of) the bottom bracket 26. As mentioned above for the exemplary embodiment of the present invention, the inner diameter of the bush bearings 26a corresponds to the outer diameter of the crank shaft 30. Depending on the inner diameter of the bottom bracket shell 24 (compared to the outer diameter of the bush bearings 26a), the bush bearings 26a may be fixed to the bottom bracket shell 24 directly or via an adapter, called cap 26b. Such a cap 26b is preferably made of an aluminum alloy and has preferably an annular shape. Throughout this disclosure, “preferably” should be understood to at least mean “optionally”.

The cap 26b is preferably provided with a step 38 (e.g., an annular shoulder), defining a part which is covering (e.g., at least partially covering) the front side (e.g., end face) of the bottom bracket shell 24, and a projecting part (e.g., an annular projection) which is pressed in (e.g., press-fit in) the bottom bracket shell 24. Alternatively, the bush bearings 26a may be fixed directly to the bottom bracket shell 24, in which case the bottom bracket shell 24 is preferably provided with a step 38 (e.g., shoulder) on each side, defining a receptacle for the bush bearing 26a, with the bush bearing 26a being pressed into (e.g., press-fit in) the bottom bracket shell 24.

In accordance with an alternative embodiment of the present invention, the bush bearings 26a are pressed on (e.g., fixedly connected to) the crank shaft 30, with the bush bearings 26a being borne (e.g., pivotably borne) within the receptacle of the bottom bracket shell 24. In accordance with this alternative embodiment, the bush bearings 26a are configured as “friction bearings”, for operating by way of direct, sliding contact.

The upper part of the fork 8 may be referred to as a fork shaft 8a. On top of the fork shaft 8a, a stem 40 is mounted. The stem 40 may be mounted to the fork shaft 8a in any suitable manner. For example, the stem 40 may be conventionally mounted to the fork shaft 8a by press-fitting. As another example, the stem 40 may be mounted to the fork shaft 8a by way of clamping ring, as described in U.S. patent application Ser. No. 12/069,291, which was filed Feb. 8, 2008. The entire disclosure of U.S. patent application Ser. No. 12/069,291 is incorporated herein by reference.

The handlebar 42 is mounted (e.g., in a conventional manner) on the stem 40 for steering the front wheel 10. The head tube 18 is bearing the fork shaft 8a by way of at least one, preferably two bush bearings 44, one at the upper end of the head tube 18, and one on the lower end of the head tube 18. In accordance with the exemplary embodiment, the bush bearings 44 are the same as the bush bearings 26a (e.g., the bush bearings 44 are “friction bearings”), except that they may be different sizes. The inner diameter of the bush bearings 44 corresponds to (e.g., is substantially the same as, such as by being slightly larger than) the outer diameter of the fork shaft 8a. The outer diameter of the bush bearing 44 is the same as or larger than the inner diameter of the head tube 18, so that the bush bearings 44 are fixed to the head tube 18.

In the exemplary embodiment of the present invention, the bush bearings 44 are fixed to the head tube 18 directly. The head tube 18 is preferably provided with a step 38 (e.g., shoulder) at each end, for defining a receptacle for the bush bearing 44, with the bush bearing 44 being pressed into (e.g., press-fit in) the head tube 18.

In accordance with an alternative embodiment of the present invention, the bush bearings 44 are pressed on (e.g., fixedly connected to) the fork shaft 8a, with the bush bearings 44 being borne (e.g., pivotably borne) respectively within the receptacles of the head tube 18. In accordance with this alternative embodiment, the bush bearings 26a are configured as “friction bearings”, for operating by way of direct, sliding contact.

It is also possible for a conventional ball bearing to be used at the lower end of the head tube 18 instead of the lower bush bearing 44. It is further possible for a conventional ball bearing to be used at the upper end of the head tube 18 instead of the upper bush bearing 44.

It will be understood by those skilled in the art that while the present invention has been discussed above with reference to exemplary embodiment(s), various additions, modifications and changes can be made thereto without departing from the spirit and scope of the invention as set forth in the claims.

What is claimed is:

1. A bicycle, comprising:
a frame with a bottom bracket shell; and
a bottom bracket for bearing a crank shaft having crank arms carrying pedals, wherein
the bottom bracket is held by the bottom bracket shell, and
the bottom bracket comprises at least one bush bearing.

2. The bicycle of claim 1, wherein:
the bush bearing has an the inner diameter;
the crank shaft has an outer diameter; and
the inner diameter of the bush bearing is substantially the same as the outer diameter of the crank shaft.

3. The bicycle of claim 1, wherein:
the bush bearing has an outer diameter;
the bottom bracket shell has an inner diameter; and
the outer diameter of the bush bearing is smaller than the inner diameter of the bottom bracket shell.

4. The bicycle of claim 3, comprising an adapter, wherein:
the adapter comprises a cap; and
the bush bearing is fixed to the bottom bracket shell by way of the cap.

5. The bicycle of claim 4, wherein the cap is made of an aluminum alloy.

6. The bicycle of claim 4, wherein:
the cap comprises a step and a projecting part;
the step at least partially covers an end of the bottom bracket shell; and
the projecting part is press-fit in the bottom bracket shell.

7. The bicycle of claim 1, wherein:
the bush bearing has an outer diameter;
the bottom bracket shell has inner diameter; and
the outer diameter of the bush bearing is at least as large as the inner diameter of the bottom bracket shell.

8. The bicycle of claim 1, wherein the bush bearing is directly fixed to the bottom bracket shell.

9. The bicycle of claim 8, wherein:
the bottom bracket shell comprises a step that at least partially defines a receptacle for the bush bearing; and
the bush bearing is press-fit in the bottom bracket shell.

10. The bicycle of claim 1, wherein:
the bush bearing is a first bush bearing;
the bicycle comprises a second bush bearing carried by the bottom bracket shell;
the bottom bracket shell has opposite first and second ends;
the first bush bearing is closer to the first end of bottom bracket shell than to the second end of bottom bracket; and
the second bush bearing is closer to the second end of bottom bracket shell than to the first end of bottom bracket.

11. The bicycle of claim 10, wherein the first and second bush bearings are distant from one another.

12. A bicycle, comprising:
a frame with a head tube for bearing a fork shaft by way of at least one bush bearing.
